(19) United States
(12) Patent Application Publication
(10) Pub. No.: US 2011/0047140 A1
(43) Pub. Date: Feb. 24, 2011

(54) Computer System and Method for Providing Real-World Market-Based Information Corresponding with a Theoretical CAD Model and/or RFQ/RFP Data

(75) Inventor: David Mitchell Free, (US)

Correspondence Address: KING & SPALDING, 1180 PEACHTREE STREET , NE, ATLANTA, GA, 30309-3521, US

(73) Assignee: MFG.com. Inc., Atlanta, GA (US)

(21) Appl. No.: 12/940,734

(22) Filed: Nov. 5, 2010

Related U.S. Application Data
(63) Continuation of application No. 11/740,574, filed on Apr. 26, 2007.

(51) Int. Cl. G06F 17/30

(52) U.S. Cl. 707/706; 707/769; 707/741; 707/E17.108

(57) ABSTRACT

A market-based search system uses a digital geometric CAD model as a filter against other digital geometric CAD models that have been used or that may be used to produce actual products and that have real-world cost and other transactional data. Specifically, a digital CAD model is used as an index into market-based data. A geometry based search engine can perform a first pass of comparing indexed parameters derived from the CAD model provided in a search query against index data of an indexed CAD assets database. A transaction search engine can then be used to perform a second pass on the results from the geometric based search in order to match any transactional data, process data, or technical attribute data of the CAD model with real-world transactional data and/or process data associated with CAD models discovered by the indexed data search.

### TECHNICAL FIELD

The invention relates to a computer system for matching computer-aided design (CAD) models of individual components or complete assemblies with real-world transactional data for the purpose of automating the process of determining market-related information such as pricing, optimal manufacturers, optimal manufacturing processes or cost comparison of product features and attributes. More particularly, the invention relates to a computer system for uncovering real-world transactional data that may be relevant to a theoretical CAD model and desired request for quote/proposal (RFQ/RFP) data.

### BACKGROUND OF THE INVENTION

With computers, engineers and designers are able to produce digital computer aided design (CAD) models of products with ease. Engineers and designers can test these CAD models in a virtual computer world without the need for producing actual physical objects, nor testing the performance of these physical objects. This has significantly advanced product design and development.

However, when someone desires to actually produce a physical product that is based on a digital CAD model of the product, ascertaining information such as market pricing or the ideal process(es) by which to manufacture the physical product can be very difficult and challenging. Typically, when physical copies of the product based on the digital CAD model are desired, the CAD model, along with specifications for associated information such as materials, manufacturing processes, capabilities, experience, labor, logistics, etc. would be sent in the form of a Request for Quotation (RFQ) to a manufacturer who may have the capability of manufacturing the product based on the CAD model.

The manufacturer will usually analyze the CAD model to develop a cost estimate for producing the product based on specifications provided in the RFQ. The manufacturer will then provide this cost estimate to the person requesting the quotation, who can be a buyer. A buyer can include professionals in purchasing, sourcing, procurement, product design, manufacturing, and many other persons. Other people who could request the quotation can include, but are not limited to, a supplier who is checking on prices his company may have quoted in the past for similar parts.

This cost estimation process, in which a buyer may ask multiple, different manufacturers for individual cost estimates (also known as sourcing), can be very time consuming and labor intensive. Through this sourcing process, a buyer may or may not identify the ideal manufacturer who has the required expertise, equipment, capacity and credentials to manufacture the product being sourced. If a manufacturer has made products similar to those being sourced by a buyer, then the costs to produce such products should be lower for that manufacturer compared to a manufacturer who has not made similar products and therefore must acquire new equipment, re-tool and/or develop new process expertise in order to manufacture the product. Usually, identifying a manufacturer with experience producing similar products to a product being sourced will result in cost savings to the buyer.

In addition to soliciting real-world cost estimates from independent manufacturers, a buyer can also use certain conventional software that can estimate manufacturing costs based on the digital CAD model. Such cost estimation software typically uses parameters of the CAD model such as the geometric features, tolerances, surface finishes and materials of the specified product to generate estimates for producing the product by various manufacturing processes. Conventional cost estimation software can take these parameters from the CAD model and use them in mathematical equations derived by the developer of the cost estimation software.

While conventional cost estimation software based on mathematical equations does work, it is very complicated and can consume significant computer power/resources because of the complexity of the equations employed, and the number of variables involved in the computations. This software can also require significant human intervention. Another drawback of conventional cost estimation software is that it only produces estimates based on a particular software developer's algorithm and is not necessarily reflective of real-world pricing, optimum manufacturing process selection, or impactful market conditions for the product to be produced.

Conventional cost estimation software may consider the geometry, shape and mathematical characteristics of the digital CAD model (or assembly of CAD models) to arrive at its cost estimates, without assessing any real-world conditions that also have a significant direct impact on the cost of manufacturing a particular object. Examples of real-world conditions include, but are not limited to, prices for which previous similar products have been produced by one or more suppliers, specialized capabilities of particular suppliers that might enable them to produce the products at lower prices or in higher quality, or information about particularly ideal processes successfully in the past to manufacture similar products.

Such estimates generated by conventional software that do not assess real-world conditions may not have any direct relationship to, or awareness of, what manufacturers may ultimately charge a buyer for producing a given product. Or more importantly, estimates produced by conventional software may not provide any information or insight on what manufacturers have charged in the past for producing products that match or are similar to the requested product.

Other problems faced by buyers, other than those caused by typical cost estimation software, include maintaining a history and database of designs and projects out-sourced and/or produced by a single company. Frequently, large companies who maintain offices in many geographic regions, such as in different countries, cannot maintain a centralized database of assets consumed and/or produced by the respective offices. For example, a company that manufactures aircraft or parts of aircraft in many different countries in which the company maintains separate manufacturing facilities usually is not able to maintain a centralized database of aircraft parts made and consumed by the single global company.

One reason why such companies do not maintain centralized databases is because of the amount of overhead cost that may be needed to establish and maintain such globally-integrated databases. Every company uses its own preferred combination of technologies to support its product development efforts, and these are nearly always different from those of another company. Often, multinational companies grow by acquisition which means that an acquiring company may purchase or completely consume an unrelated, yet competing second company. The acquired second company often has computer systems and associated computer records that are completely different and incompatible with the computer system and associated computer records of the acquiring first company. The costs to integrate the two entirely different computer systems are often too large, and the technical issues too complex, and therefore are not pursued by the single global company.

In such a scenario, the single company comprised of the two different companies may not be effectively communicating between the two different companies. Therefore, the first company could be producing and/or consuming products in a completely different manner relative to the second, acquired company. Such a situation in which branches of a single company are operating completely independent of each other and without any centralized communication of assets produced or consumed (or both) by the branches is very common, entirely inefficient and can add significantly to the operating costs of the single company.

Accordingly, there is a need in the art for a method and system that provides a centralized computer database of assets that are produced or consumed by a single company. Another need in the art is for a method and system that can allow a centralized computer database of CAD data and/or transactional data to be searched using CAD data as a way to for search for CAD data of similar products and the transactional data associated with the CAD data of the similar products.

One great opportunity to reduce the cost of manufacturing a product is during the design phase. The decisions that designers and engineers make as they design new products directly and profoundly affect the ultimate production cost. However, designers and engineers have little or no insight into the cost implications of the decisions they make during the design process. Thus, there is another need in the art for a method and system to enable designers, engineers, and other people who are involved with producing new products to discover market-based information in real-time for the products they are designing.

There is further a need in the art for a system that can provide key, real-world market and/or transactional information, such as cost estimates or manufacturing processes, related to producing specific products, without using complex mathematical equations that can consume computer processing power. If this need is addressed, this would in turn allow designers, engineers, and people involved in the development of new products to identify and/or compare features and attributes that are more or less costly, earlier in the design process, so that designs can be adjusted accordingly.

Another need in the art exists for a method and system that allows buyers of custom manufactured parts and assemblies to automatically identify new or past manufacturers of a particular product based on the attributes of the product being sourced.

And another need in the art exists for a method and system that allows supplier companies to investigate their past proposals and projects, for example, past projects with particular customers, and similar projects, based on the CAD data and or transactional information in an RFQ.

### SUMMARY OF THE INVENTION

A method and system for maintaining and providing transactional information in connection with designing, outsourcing, and/or manufacturing of objects can provide accurate marketplace information, such as cost and supplier information, based on a digital computer-aided design (CAD) model that may be supplied by a computer user. In other words, a computer user of the system can conduct a search query on the system which maintains transactional information and CAD data using a digital CAD model of an object, such as a digital two-dimensional (2-D) or three-dimensional (3-D) geometric model of an object. The geometric model can be generated from CAD software.

Once matching or similar geometric CAD models in the database are uncovered by a geometry based search engine after an index based search, the system may retrieve additional information associated with the similar CAD models, including but not limited to transactional data (such as cost or supplier) and process data. The system can then display the matching or similar CAD models adjacent to their associated transactional information and technical attribute data (such as manufacturing process, material and tolerance) on a viewing device for display and review by the computer user.

The computer user can then refine or filter these search results further by supplying additional transactional data, process data, and/or technical attribute data associated with the computer user's digital CAD model.

To initiate a search with a digital CAD model, a geometry based search engine can create index data based on the digital CAD model. This index data can comprise values from one or more shape signatures that are unique and are based on the geometry and topology of the digital CAD model. According to one exemplary embodiment, a shape signature can comprise calculating lengths of vectors taken from points in space relative to the geometric CAD model. The inventive system can also include other types of shape signatures. Other types of shape signatures can include, but are not limited to, shape distribution functions, computing reflective symmetry descriptors of two-dimensional and three-dimensional shapes, representing a shape as a measure of reflective symmetry for an arbitrary three-dimensional voxel model for all planes through the center of mass of a CAD model, and skeletal graphs.

The geometry based search engine can comprise an indexing software module that provides the algorithms for unique shape signatures based on the geometry of the digital CAD model. The results or numerical values from these unique shape signatures can form the index data of the indexed CAD assets database.

The geometry based search engine can comprise off-the-shelf software. The indexing software module can also comprise a portion or one or more subroutines of the geometry based search engine. In addition to creating index data for each digital CAD model provided by a user in a an uploaded CAD file, the indexing software module can also create index data for all digital CAD files contained in a real-world transactional database.

The indexing software module can create index data for digital CAD model files in the real-world transaction database as they are uploaded or the indexing software module can perform batch processing based on searches of the transactional database in time increments (hourly, daily, weekly, etc.).

In other words, this indexing process of the real-world transactional database can be performed automatically by existing, off-the-shelf indexing software module. To build an indexed CAD assets database comprising values from shape signatures and to associate them with a transactional database that has transactional data, process data, technical attribute data, and identification information that can be accessed by search engines, the digital CAD models can be separated from the transactional data and process data, if the computer records for the digital CAD files contain all of these data types. This can be accomplished with off-the-shelf software or with manual support (or a combination thereof).

Then, a mapping table can be created by the indexing software module so that data from the indexed CAD assets database is associated with the data of the transactional/process database. With this mapping table created by the indexing software module, a non-geometry based search manager of the inventive system can retrieve or pull full records from the real-world transactional database associated with digital CAD models discovered from a geometric index data search.

As new data of a CAD model and corresponding transactional and process data are received, the geometric CAD model can be separated from the transactional or process data and the CAD model can be indexed and then added into the indexed CAD assets database that can be searched with the geometry based search engine. As noted above, index data can be calculated by the geometry based search engine from the geometry and topology of a digital CAD model alone, or the index data can be derived from technical attribute data of the CAD model, or both.

Similar to the indexing process, with off-the-shelf software or with manual support (or a combination thereof), technical attribute data of a CAD model from multiple records can be calculated and used by a non-geometry based search manager for refining results from prior geometric index data searches.

Exemplary technical attribute data of a CAD model can include, but is not limited to, geometric features such as vertices, edges, faces and bodies, unit measure of size, unit measure of weight, mass, center of mass, density, axes of inertia, principal moments of inertia, surface area, volume, diameter, length, width, height, aspect ratios, bounding box parameters, other topology data, and any other data that can be derived from the geometric CAD model. Technical attribute data of a CAD model can further include model level data.

Model level data is often (at the discretion of the CAD user) stored in the digital CAD file, and is often associated with the geometry in the CAD model, but cannot be derived from the model geometry. Model level data can include, but is not limited to, any text annotations, callouts listed in a CAD drawing adjacent to model geometry, title block, notes, Product Manufacturing Information (PMI) such as Geometric Dimensioning and Tolerancing (GD&T) information, Group Technology (GT) codes, design features, and manufacturing instructions, and other like parameters.

Like technical attribute data, transactional data can be used by a computer user with a non-geometry based search manager to further refine results generated from an geometric index data search or if the computer user wishes to initiate a new search without a CAD model. The transactional data can include, but is not limited to, any data associated with request for quotes (RFQs) or request for proposals (RFPs), such as cost information associated with the products of RFQs and/or RFPs, manufacturing process information and supplier information. Transactional data can also include, but is not limited to, industry, a company name, company size, contact information of supplier, supplier type of business, quality certifications, special business status, part number, star rating, industry, target price, baseline price, ITAR compliance required, active unit of measure, geographical location of supplier or buyer and quantity of goods.

Similar to transactional data and technical attribute data, process data can be supplied by the computer user to a non-geometry based search manager and that can further refine results from earlier geometric index data searches. Process data can include, but is not limited to, information such as manufacturing process, material, finish, tolerance, part number, part name, or product version number.

### BRIEF DESCRIPTION OF THE DRAWINGS

FIG. 1 is a functional block diagram of computer architecture to practice the technology according to one exemplary embodiment of the invention.

FIG. 2 illustrates a sample computer aided design (CAD) model with technical attribute data and an exemplary list of transactional data and process data found in the real-world transactional database according to one exemplary embodiment of the invention.

FIG. 3 illustrates an exemplary display of results from a geometry only search using geometry index data 800, 800A, 800C and technical attribute data according to one exemplary embodiment of the invention.

FIG. 4 illustrates an exemplary display of the sample computer aided design (CAD) model of FIG. 2 that was provided by a user and which also lists relevant technical attribute data of the CAD model that may have been searched according to one exemplary embodiment of the invention.

FIG. 5 illustrates an exemplary selection of transactional data and process data similar to FIG. 2 that can be used to filter the search results of FIG. 3 or to initiate transactional only searches in which only a few parameters have been selected by a user according to one exemplary embodiment of the invention.

FIG. 6 illustrates an exemplary display of refined or filtered results from a transactional and process search that used the parameters selected in FIG. 5 to further filter the geometric only search results illustrated in FIG. 3 according to one exemplary embodiment of the invention.

FIG. 7A illustrates a schematic of how index data may be calculated from a geometric CAD model according to one exemplary embodiment of the invention.

FIG. 7B is a bar graph illustrating magnitudes of vectors A-C relative to a first point positioned in space relative to the geometric CAD model illustrated in FIG. 7A.

FIG. 7C is a bar graph illustrating magnitudes of vectors D-E relative to a second point positioned in space relative to the geometric CAD model 200 illustrated in FIG. 7A.

FIG. 8 is a diagram illustrating five exemplary tables that simulate how data can be managed by the geometry based search engine and the transactional search engine according to one exemplary embodiment of the invention.

FIG. 9 is a logic flow diagram illustrating an exemplary method for creating and maintaining an indexed CAD assets database that can be used in exemplary embodiments of the invention.

FIG. 10 is a logic flow diagram illustrating an exemplary process for Identifying Similar Real-World Products Using indexed versions of CAD models according to one exemplary embodiment of the invention.

### DETAILED DESCRIPTION OF EXEMPLARY EMBODIMENTS

The invention may be embodied in hardware or software or a combination thereof. The invention can be characterized as market-based search system in which a digital, geometric CAD model can be used as a filter against other digital, geometric CAD models that have been used or that may be used to produce actual products and that have real-world transactional data, including, but are not limited to, any data associated with request for quotes (RFQs) or request for proposals (RFPs), such as cost information associated with the products of RFQs and/or RFPs, manufacturing process information and supplier information. In a sense, a provided digital CAD model is used as an index into market-based information.

A geometric search engine can compare geometric parameters of a CAD model provided as the basis of a search query against a database of real-world CAD assets. The results of this search query of real-world CAD assets can then be used to identify any real-world transactional data and/or process data associated with other matching or similar CAD models previously stored in a database.

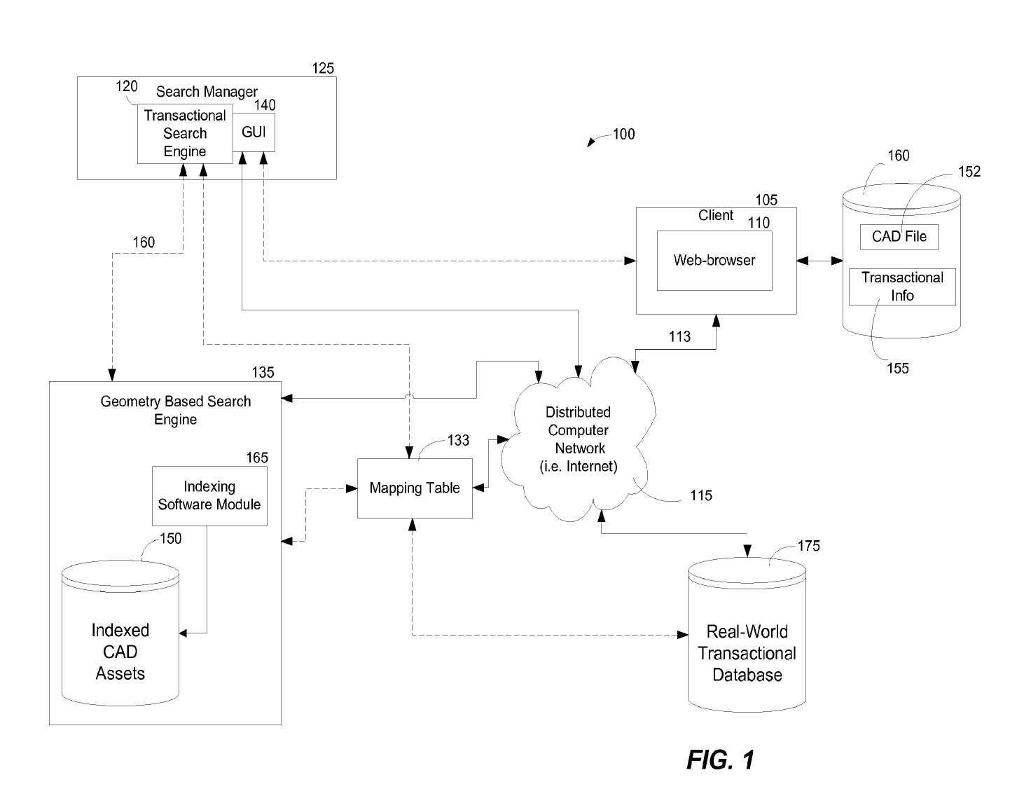

Referring now to the drawings, in which like reference numerals designate like elements, FIG. 1 is a functional block diagram of an exemplary computer architecture for a real-world transactional based computer system 100 according to one exemplary embodiment of the invention. The computer system 100 can comprise a four-part architecture that includes a client computer 105, a Search Manager 125, a Geometry based search Engine 135 and a Real-World Database 175. The entire system 100 or each discrete part may run on one or more servers.

The client computer 105 can comprise any form of computer, for example, a desktop, laptop, or handheld computer. The client computer 105 can execute and run a web browser 110. Alternatively (and not illustrated), instead of a web-browser 110, the client computer 105 may be provided with a stand-alone client application (executable) that allows access to the search manager 125. All communications between and among all components of the system 100 may be direct programmatic links or through computer networks 115, for example, the Internet.

The real-world transactional based computer system 100 may operate in a networked environment using logical connections to one or more other remote computers, such as remote client computers 105. The remote client computer 105 may be another personal computer, such as a hand-held computer, a server, a client such as web browser, a router, or a network PC. The logical connections depicted in FIG. 1 can include additional local area networks (LANs) and a wide area networks (WANs) not shown. Such networking environments are commonplace in offices, large industrial facilities, enterprise-wide computer networks, intranets, and the Internet.

The computers illustrated in FIG. 1 may be coupled to a LAN through a network interface or adaptor. When used in a WAN network environment, the computers may typically include a modem or other means for establishing direct communication lines over the WAN.

In a networked environment, program modules may be stored in remote memory storage devices. It will be appreciated that the network connections shown are exemplary and other means of establishing a communications link between computers other than depicted may be used.

Moreover, those skilled in the art will appreciate that the present invention may be implemented in other computer system configurations, including other hand-held devices besides hand-held computers, multiprocessor systems, microprocessor-based or programmable consumer electronics, networked personal computers, minicomputers, mainframe computers, and the like.

The invention may be practiced in a distributed computing environment as illustrated in FIG. 1, where tasks may be performed by remote processing devices that are linked through a communications network such as the distributed computer network 115. In a distributed computing environment, program modules may be located in both local and remote storage devices and any or all modules may be executed on one or more computer servers.

The client computer 105 can comprise any general purpose computer capable of running software applications and that can be portable for mobile applications. The client computer 105 can communicate with the computer network 115 through a communications link 113. The communications link 113 can be a wire or a wireless connection, depending upon the application of the client computer 105. Typical wireless links include a radio frequency type in which the client computer 105 can communicate with other devices using radio frequency (RF) electromagnetic waves. Other wireless links that are not beyond the scope of the invention can include, but are not limited to, magnetic, optical, acoustic, and other similar wireless types of links.

Many of the communication links between elements in FIG. 1 are illustrated with dashed lines which can represent virtual connections. Meanwhile, solid lines in FIG. 1 between elements can represent actual or real connections between the elements. One of ordinary skill in the art recognizes that all of the virtual connections could easily be replaced with direct or actual connections without departing from the scope of the invention.

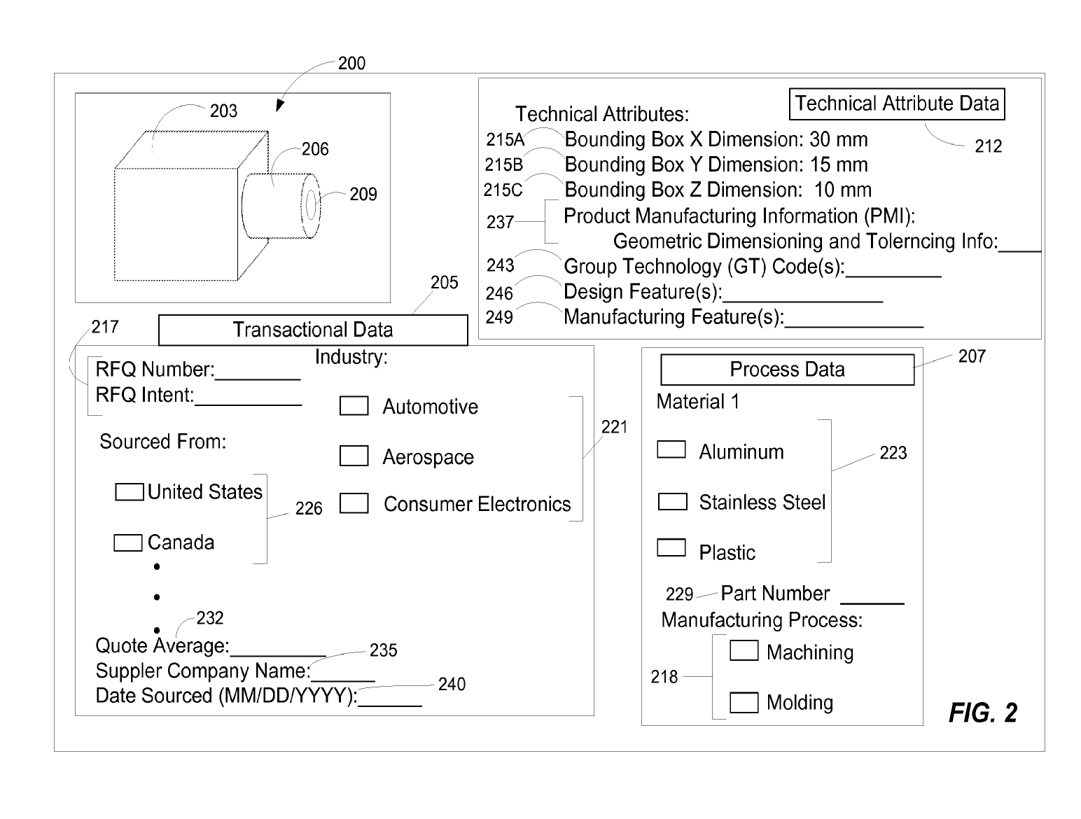

The client computer 105 may have access to a computer aided design (CAD) file 152 stored in a digital storage media 160, such as on a hard disk drive. The CAD file 152 may comprise geometric images or views of a product as well as dimensions, manufacturing instructions, title information, and other relevant information. More specifically, CAD files 152 may comprise digital geometry data (lines, shapes, topology, etc.) that form a CAD model 200 (see FIG. 2) and technical attribute data. The technical attribute data can comprise model level data.

Exemplary technical attribute data within the CAD file 152 may include, but are not limited to, geometric features such as vertices, edges, faces and bodies, unit measures of size, unit measure of weight, mass, center of mass, density, axes of inertia, principal moments of inertia, surface area, volume, diameter, length, width, height, aspect ratios, bounding box parameters, other topology data, and any other data that can be derived from the geometric CAD model.

The digital geometry data forming CAD model 200 can be in any two-dimensional (2D) or three-dimensional (3D) proprietary CAD format, such as DXF or DWG, made by Autodesk, SLDPRT, made by Solidworks Corporation, SAT, made by Spatial Corporation, and PRT, made by Unigraphics Solutions. The CAD file 152 can also comprise digital geometry data for displaying CAD model 200 in any industry standard format such as STEP or IGES, or any one or more image file (s) in any conventional image format, such as TIFF, PDF or JPEG.

As noted above, the technical attribute data 212 of a CAD model 200 may also include model level data. Model level data can include, but is not limited to, any text annotations, callouts listed in a CAD drawing adjacent to model geometry 200, title block, notes, Product Manufacturing Information (PMI) such as Geometric Dimensioning and Tolerancing (GD&T) information, Group Technology (GT) codes, design features, and manufacturing instructions, and other like parameters.

Within the CAD file 152 or in a separate transactional file 155 on storage media 160, the client computer 105 may store transactional data and/or process data related to a CAD model 200 (see FIG. 2). Transactional data may include, but is not limited to, request for quote (RFQ) number, RFQ intent, RFQ purpose, number of quotes received, number of quotes prepared, quote average, quote median, quote awarded, quote by date, anticipated award date, delivery date, units, number of RFQs awarded, number of RFQs posted, buyer company name, supplier company name, company size, contact information of supplier, supplier type of business, quality certifications, special business status, star rating, industry, target price, baseline price, ITAR compliance required, active unit of measure, geographical location of supplier or buyer and quantity of goods.

The process data that may be stored in transactional file 155 may include, but is not limited to, the manufacturing process used to make the object represented by the CAD model, material, finish, tolerance, material grade, tooling, part number, part name, part or product version number.

The web browser 110 (or stand alone application not illustrated) running on the client computer 105 can access a search manager 125 through a graphical user interface (GUI) 140 running on a computer. The client computer 105 can be coupled to a computer network 115, such as the Internet. With the search manager 125, a computer user on client computer 105 can use a CAD model contained within the CAD file 152 to initiate a market-based search for products matching or similar to the CAD model that have been made or were quoted on the system 100. For example, relevant products may have been part of a request for proposal (RFP) and/or request for a quote (RFQ) that were sourced using system 100 and such data would be stored in the real-world database 175.

The search manager 125 can include a transactional search engine 120, a graphical user interface (GUI) 140, and other software code for receiving search queries and requests from the client computer 105. The search manager 125 can be coupled to the computer network 115. The client computer 105 and search manager 125 can communicate with one another over the computer network 115 and through the GUI 140. Meanwhile, the search manager 125 can communicate with the geometry based search engine 135 over the computer network 115 or it may communicate with the geometry based search engine 135 with a direct link 160. The geometry based search engine 135 can comprise an indexed database 150 of CAD assets.

The real-world transactional database 175 can comprise transactional data derived from earlier searches on the system 100 as well as data that tracks the business (quotes as well as actual work completed) by designers and manufacturers who connect over the computer network 115, such as the Internet. The real-world transactional database 175 also comprises real-world data that is exchanged between designers and manufacturers over the Internet 115. This real-world data is created and maintained by websites on the Internet 115 and stored in the real-world database 175. These websites can facilitate transactions between designers and manufacturers that are added to the real-world database 175 daily.

The websites that promote business allow a designer to send out a request for quote (RFQ) or a single request for proposal (RFP) on a project that can be received by many different manufacturers. One exemplary website that facilitates such transactions between designers and manufacturers is MFG.com, which is the assignee of this invention as of the filing date of this disclosure.

Each manufacturer who uses a website (supported by real-world transactional database 175) to receive RFQs or RFPs can respond through the website with a quote or proposal. These quotes and proposals, as well as transactional and CAD data provided with the RFQs and RFPs, can be maintained in the real-world database 175. The CAD models in this real-world database 175 can be indexed with the indexing software 165 to form the indexed CAD assets database 150.

The geometry based search engine 135 may further comprise indexing software module 165 that can create and maintain the indexed CAD assets database 150. The geometry based search engine for indexing CAD assets may comprise off-the-shelf software sold under the brand name Sketch & Search, made by CADFind, Ltd., or 3DSearchit, from Geometric Software Ltd., or iSeek, made by iSeek Corp. or Geolus by Unigraphics Solutions.

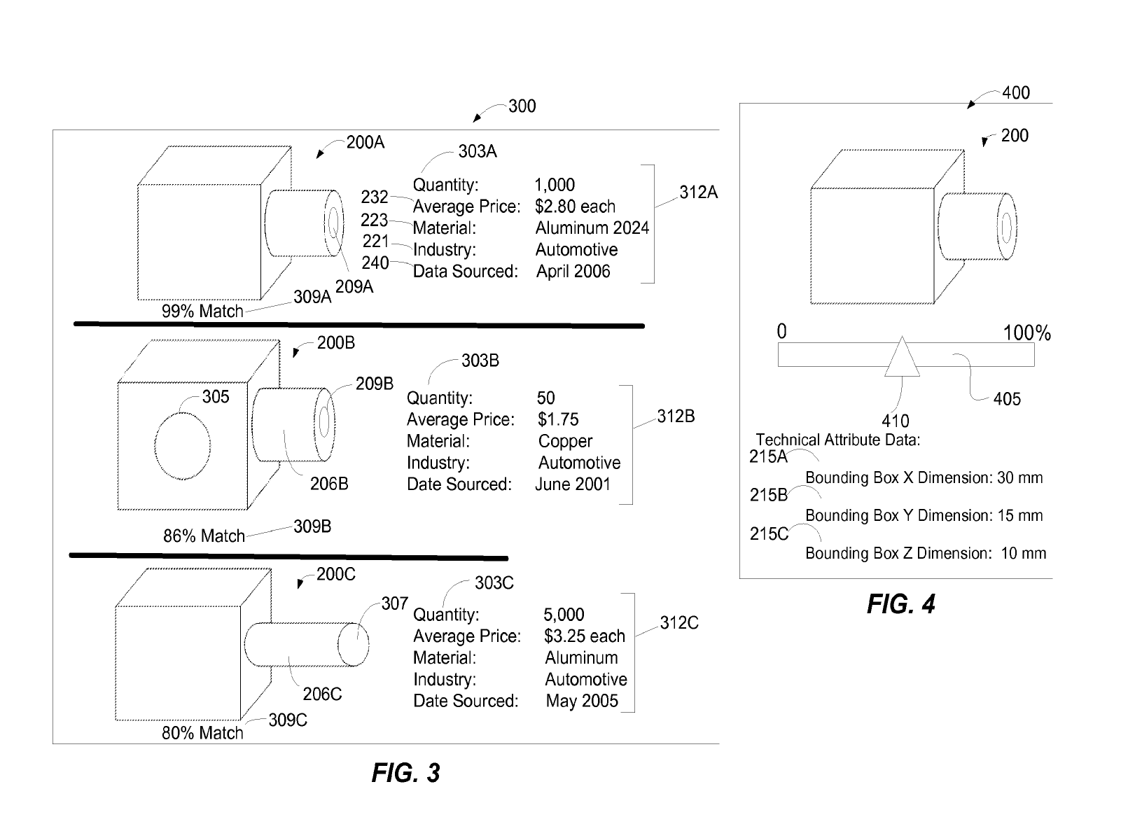

The indexed CAD assets database 150 may comprise values shape signatures that are derived from the CAD models 200A, 200B, 200C (see FIG. 3) supplied in RFQs, RFPs, quotes, and proposals that are exchanged between buyers and manufacturers over the computer network 115, such as the Internet, and through a website. The indexed CAD assets database 150 may include, but is not limited to, equations describing: shapes of objects, boundary, and profile information, etc.

Various indexing software module 165 may employ different techniques to create index CAD data that comprises values from unique shape signatures. In general, existing off-the-shelf indexing software module 165 can use proprietary mathematical algorithms to calculate a shape signature, which is unique to each digital CAD model 200.

According to one exemplary embodiment, orthogonal views of a digital CAD model 200 can be calculated by the indexing software module 165. The indexing software module 165 can then create a distance map which places shapes from the orthogonal views in virtual space relative to the three-dimensional coordinate system of the digital CAD model 200. The software 165 can then assign vectors to the digital CAD model 200, according to the search tolerance selected by the computer user. Such index data can be calculated for each digital CAD model 200A, 200B, and 200C in the real-world database 175 and stored in the indexed CAD assets database 150 in such a way that future search queries can quickly retrieve digital CAD models 200A-C that match or are similar to a submitted CAD file 152 that may contain a digital CAD model 200.

The indexing software module 165 of the geometry based search engine 135 may create a mapping table 133 which maps the indexed CAD assets database 150 to the real-world database 175. With this mapping table 133, the search manager 125 can retrieve information, including but not limited to, transactional, process, or other data from the real-world database 175 and which corresponds with CAD models 200A, 200B, 200C that are discovered by the geometry based search engine 135 and that are related to a CAD model 200 that is the subject of a search query. Further details of the mapping table 133 will be described below in connection with FIG. 8.

The search manager 125 and geometry based search engine 135 that communicate with the indexed CAD assets database 150 may each reside on computer servers which may be separate from one another. One of ordinary skill in the art will appreciate that while the search manager 125 and geometry based search engine 135 are depicted as separate software components that can be positioned at different physical locations and executed on separate, different computers and/or servers, they could also be integrated into a single system that resides at one physical location without departing from the scope and spirit of the invention.

The search manager 125 and the transactional search engine 120 can comprise off-the-shelf software for conducting text-based searches in the real-world database, based upon information provided by the client 105. For example, the transactional search engine 120 of the search manager 125 can include software sold under the brand name Oracle, made by Oracle Corp., Adaptive Server Enterprise made by Sybase Corp., Access made by Microsoft Corp., and R/3 made by SAP AG. The transactional search engine 120 can communicate with the real-world transactional database 175.

The geometry based search engine 135 can also comprise off-the-shelf software that can search the indexed CAD assets database 150 for the purpose of discovering other CAD models 200A, 200B, 200C which match or are similar to the CAD model 200 submitted by the user. For example, the geometry-based search engine 135 can include software sold under the Sketch & Search, made by CADFind, Ltd., or 3DSearchit, from Geometric Software Ltd., or iSeek, made by iSeek Corp. or Geolus by Unigraphics Solutions.

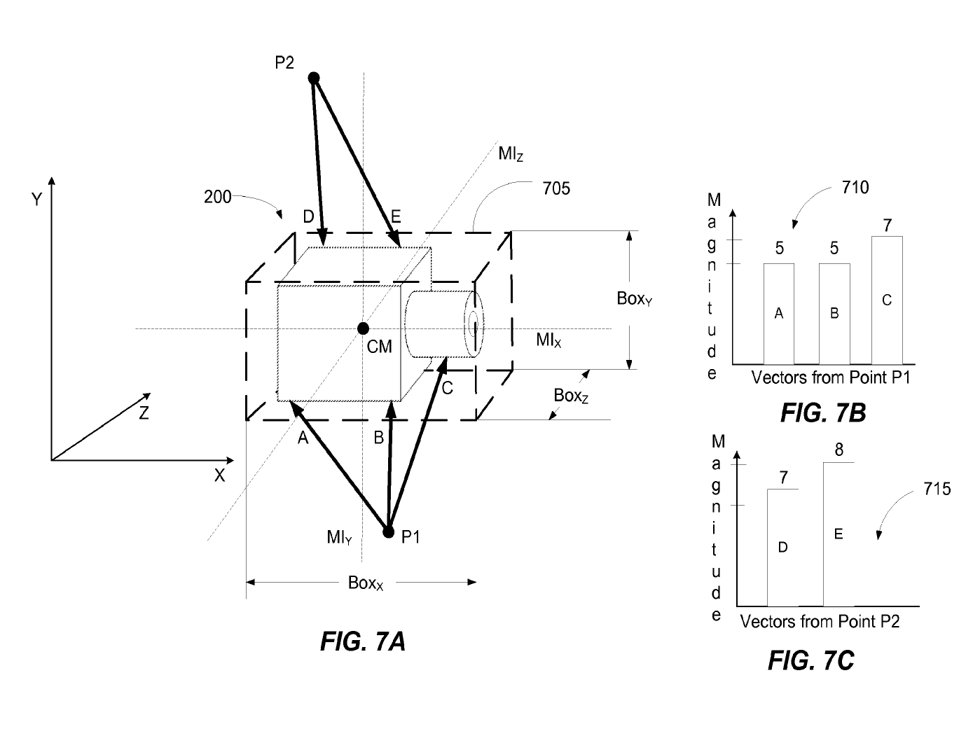

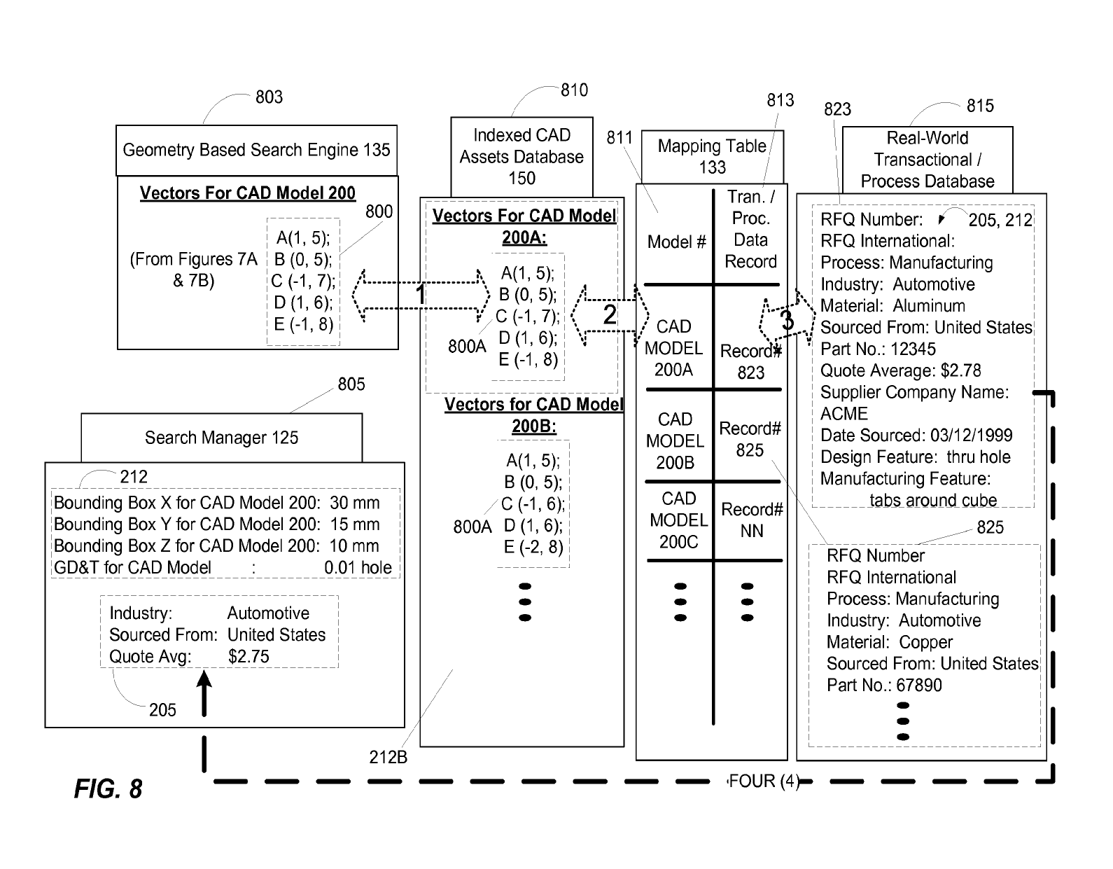

The geometry-based search engine 135 can review the digital CAD file 150, index the data by using unique shape signatures based on geometry of the CAD model 200. The index data contained within the indexed CAD assets database 150 is an abstraction of the CAD model 200 contained in the CAD file 152 and is usually sorted and indexed for increased searching efficiency. For example and according to one exemplary embodiment of the invention, the geometry-based search engine 135 can analyze the digital CAD model 200 and generate values from various unique shape signatures. One exemplary shape signature comprises measurements based on the calculations of lengths of vectors taken from points in space relative to the geometric CAD model 200. Further details of this exemplary shape signature used by the geometry based search engine 135 are described below in connection with FIG. 7.

The geometry based search engine 135, and/or other commercially available software, may also extract or calculate various technical attribute data 212 of a CAD model 200 from the CAD file 152. This technical attribute data 212 is usually not indexed by the geometry based search engine 135. However, the geometry based search engine 135 could generate index data comprising values from shape signatures that use technical attribute data 212.

As noted above, technical attribute data 212 of a CAD model 200 can comprise unit measure of size, unit measure of weight, mass, center of mass, density, axes of inertia, principal moments of inertia, surface area, volume, diameter, length, width, height, aspect ratios, bounding box parameters, other topology data, and any other data that can be derived from the geometric CAD model 200. Technical attribute data may further comprise model level information data which may include, but is not limited to, any text annotations, callouts listed in a CAD drawing adjacent to the geometry, title block, notes, product Manufacturing Information (PMI) such as Geometric Dimensioning and Tolerancing (GD&T) information, Group Technology (GT) codes, design features, and manufacturing features, and other like parameters.

Referring now to FIG. 2, this figure illustrates a sample computer aided design (CAD) model 200 with technical attribute data 212 and an exemplary list of transactional data 205 and process data 207 found in the real-world transactional database 175 and that can be used to filter geometric or shape search results or to initiate transactional only searches. The CAD model 200 of FIG. 2 comprises a digital representation of a three-dimensional (3-D) object. One of ordinary skill in the art will appreciate that all types of CAD models 200 can be processed and searched by the computer system 100. In other words, the invention is not limited to 3-D CAD models 200. CAD models 200 can also comprise two-dimensional (2-D) representations (not shown) of an object.

The CAD model 200 illustrated in FIG. 2 comprises a cube 203 that is coupled to a cylinder 206. The cylinder 206 may also include a hole 209 that penetrates entirely through the cylinder 206 as well as through the cube 203. To uncover CAD models in the indexed CAD assets database 150 that may be similar to CAD model 200, the geometry based search engine 135 can compare parameters based on the geometry of the CAD model 200 and that represent the shape of the CAD model 200.

The geometry and technical attribute data 212 of CAD model 200 illustrated in FIG. 2 is only an example representation of an arbitrary object. One of ordinary skill in the art recognizes that any other types of objects with different geometries could be supplied to the computer server 125 for searching by the geometry based search engine 135.

The geometric information of the CAD model 200 used by the geometry based search engine 135 to generate an indexed representation comprising values from one or more unique shape signatures of the CAD model 200 and compared by the geometry-based search engine 135 against records in the indexed CAD assets database 150 can derived from the geometry of the CAD model 200 contained in the CAD file 152. The indexed representation comprising one or more unique signatures can also be derived from the CAD data 212.

Which of these data may be used to generate values from one or more unique shape signatures depends on the proprietary algorithms of the particular geometry based search engine 135 employed in each implementation of the invention. In one exemplary embodiment of the invention, the geometry based search engine 135 indexes the CAD file 152 submitted by the user, and compares this index data to existing indexing data stored in the indexed CAD assets database 150 to determine matches or similarities according to a search tolerance requested by the user, and returns these matching or similar indices to the Search Manager 125.

The Search Manager 125 then reviews these matching or similar CAD objects 200A, 200B, 200C in the mapping table 133 and follows the links contained in the mapping table 133 to uncover the full records of transactional information contained in the real-world database 175 which corresponds to each matching or similar CAD model 200A, 200B, 200C found in the indexed CAD assets database 150.

The technical attribute data 212 illustrated in FIG. 2 includes a bounding box X dimension 215A of thirty millimeters (mm), a bounding box Y dimension 215B of fifteen millimeters, and a bounding box Z dimension of ten millimeters. Bounding box dimensions refer to dimensions of a theoretical parallelepiped volume (not illustrated) that completely encapsulates or envelopes an object. An exemplary bounding box is illustrated in FIG. 7, which is discussed in further detail below.

### Technical Attribute Data 212 of a CAD Model 200: Model Level Parameters

The product manufacturing information (PMI) search parameter 237 can comprise geometric dimensioning and tolerancing (GD&T) information. For example, hole 209 of CAD model 200 may need to be drilled and reamed to a tolerance of plus or minus one-thousandth of the unit of measure for the CAD model 200. For example, if the unit of measure for the CAD model 200 was inches, then hole 209 would need to be drilled and reamed to a precision of plus or minus one-thousandth of an inch. Other examples include material specification, assembly instructions, hardness (heat treating) and surface finish, perpendicularity, parallelism, concentricity, and special notes from the designer. Other GD&T information and PMI information are not beyond the scope of the invention.

Another exemplary model level parameter illustrated in FIG. 2 is a Group Technology (GT) code search parameter 243. GT codes 243 involve a system that groups similar parts together to take advantage of their similarities in design. GT codes usually comprise a taxonomic sorting scheme that can be applied to product representations to make them easier to find. GT codes 243 can help locate previous designs that might be suitable or adaptable for a new design that has features that may be similar to older designs. Multiple GT codes 243 may be supplied by a computer user if known. Also, a computer user could use any appropriate wildcard characters for searching if all digits of a GT Code 243 are not known.

Another exemplary model level parameter which can be searched with the geometry based search engine 135 includes design feature search parameters 246. Design feature parameters include holes, slots, bosses, surfaces, extrusions, faces, planes, cylinders, radii, torus, etc. For example, the hole 209 of CAD model 200 is a design feature represented by a null space within the cylinder 209. As another example, an extrusion is a design feature represented by a flat, planar shape swept along a vector, curve or spline, creating a three-dimensional shape.

Additional model level search parameters can include manufacturing feature parameters 249. Manufacturing feature parameters 249 describe elements or components that are added to a CAD model 200 for the purpose of manufacturing the CAD model 200 and are usually later removed after manufacture of the CAD model 200. For example, a manufacturing engineer may add tabs to a CAD model 200 so that the tabs can be used to hold the product while it is being manufactured. At the end of manufacturing the product, these tabs may be removed. Other similar manufacturing features are not beyond the invention.

According to one exemplary embodiment of the invention, the technical attribute data parameters 212 can be derived from the CAD model 200 by the geometry based search engine 135 and other commercially available software tools. Some technical attribute data 212 can be derived, but other technical attribute data 212 can only be recovered (through a query) if they were actually stored in the digital representation, such as manufacturing features or PMI data.

The geometry based search engine 135 through its indexing software module 165 may use several different algorithms for various geometric shape signatures that can be applied to the geometry of CAD model 200. As one non-limiting example, the geometry based search engine 135 can analyze the shape of the geometric CAD model 200 and generate various measurements such as lengths of vectors taken from points in space relative to the geometric CAD model 200. It is noted that this is just one of numerous techniques for algorithmically assessing the shape of a digital representation of an object. Other techniques are not beyond the invention.

The geometry based search engine 135 can classify the length of each vector and a direction of the vector, so that each vector has two floating point numbers. These vectors can be applied all around the geometry of the CAD model 200 so that the CAD model 200 can be represented as a set of multiple floating point numbers corresponding to the vectors. The multiple floating point numbers can comprise the index data stored in the indexed CAD assets database 150. Further details of this exemplary geometric shape signature are described below in connection with FIG. 7, which also illustrates a bounding box 705 and vectors for exemplary CAD model 200. As noted above, this exemplary shape signature comprising values associated with the magnitude of vectors positioned around the CAD model 200, is yet one example of a shape signature that may be applied to the geometry of CAD model 200.

According to one exemplary embodiment, a computer user can upload a CAD file 150 that contains the CAD model 200 to the search manager 125. The geometry based search engine 135 can then perform its calculations on the CAD model 200 with one or more shape signatures derived from the geometry of the CAD model 200. Additionally, the geometry based search engine 135 may also identify model level data which is not usually derived.

According to one exemplary embodiment, the technical attribute data 212 of a CAD model 200 may be manually provided by a user, such as by keying-in this information in a page or GUI 140 that prompts a user for the information. Alternatively, many of the geometric parameters may already be calculated from the CAD software that was used to develop the CAD model 200. In such a situation, the geometry based search engine 135, or many other commercially available software tools, may retrieve the technical attribute data 212 from a computer file 152 associated with the CAD model 200 to feed data into one or more shape signatures to form index data 800, 800A, 800B (See FIG. 8).

After conducting a search query based on the indexed data for CAD model 200 in the indexed CAD assets database 150, additional non-geometry/non-index search queries may be conducted with the search manager 125 using technical attribute data, transactional data 205, or process data 207, or any combination thereof. As noted above, transactional data 207 may include, but is not limited to, request for quote (RFQ) number, RFQ intent, RFQ purpose, number of quotes received, number of quotes prepared, quote average, quote median, quote awarded, quote by date, anticipated award date, delivery date, units, number of RFQs awarded, number of RFQs posted, buyer company name, supplier company name, company size, contact information of supplier, supplier type of business, quality certifications, special business status, Skype identification (ID), star rating, industry, target price, baseline price, ITAR compliance required, active unit of measure, and quantity of goods.

Meanwhile, process data 205 may include, but are not limited to, the process used to make the object represented by the CAD model, material, finish, material, tooling, part number, part name, and part or product version number.

The representative transactional data 205 illustrated in FIG. 2 includes: request for quote/proposal (RFP/RFQ) information 217 industry information 221; geographic location information 226; quote average information 232; supplier company name information 235; and date sourced information 240. The representative process data 207 illustrated in FIG. 2 include: process information 218; material information 223; and part number information 229. The representative technical attribute data 212 of a CAD model 200 212 of FIG. 2 includes: bounding box dimensions 215, product manufacturing information (PMI) 237; group technology (GT) code information 243; design feature information 246; and manufacturing feature information 249.

These transactional data 205, process data 207, and technical attribute data 212 may be keyed-in by a computer user using alphanumeric text, or alternatively, a computer user could select information from menu items or lists.

As noted above, instead of using software to extract technical attribute data 212 of the CAD model 200, a computer user can supply this data as illustrated in FIG. 2. Further, prior to executing the geometry index data search, a computer user can also supply the non-geometric, transactional data 205 or process data 207 or technical attribute data 212 related to the CAD model 200 such as those illustrated in FIG. 2. As will be discussed below, any non-geometric and non-index search parameters, such as transactional data 205, process data 207, or technical attribute data 212, supplied by the computer user prior to any geometry index data searching will not be used by the transactional search manager 125 until the geometry based search engine 135 has completed its geometric index data search based on shape signatures associated with the CAD model 200.

Alternatively, a computer user could elect not to conduct any geometric index data searching based the CAD model 200 and to only conduct a non-geometric and non-index data based searching that uses only the transactional search engine 120 of the search manager 125. In such an instance, the transactional search engine 120 would immediately use the non-geometric and non-index transactional data 205, process data 207, or technical attribute data 212 supplied by the computer user to conduct the search.

Also, while transactional data 205 or process data 207 have been listed according to their respective categories, one of ordinary skill in the art will appreciate that the any of this data could be listed in any order and without listing them according to any respective category.

### Transactional Data 205 of FIG. 2

The request for quote/proposal search parameters 217 can include, but are not limited to, an RFQ number and RFQ intent. The RFQ intent could comprise an alpha-numeric string that uniquely describes or provides a specific description of a request for quote (RFQ). The computer user could truncate RFQ intent information with appropriate wild card characters for database searching known to one of ordinary skill in the art. A computer user could key-in this RFQ/RFP data once the CAD model 200 is uploaded to the search manager 125.

The industry information search parameter 221 can comprise data that describes a category of industry associated with the CAD model 200 or in which the object represented by the CAD model 200 is used. As illustrated in FIG. 2, industry information options include Automotive, Aerospace, and Consumer Electronics. Other industry options are not beyond the scope of the invention. For example, other industry options include, but are not limited to, fluids engineering, bioengineering, nanotechnology, environmental engineering, industrial electronics, and other like industries. Overlap can exist among the industry options depending on the application of the object represented by the CAD model 200.

The country source information search parameter 226 can list various countries such as the United States and Canada. Any other country could be listed, such as the major manufacturing countries, like China, Taiwan, Malaysia, and Europe.

The quote average search parameter 232 can include any amount of currency associated with the costs to produce the object represented by the CAD model 200. While not illustrated in FIG. 2, options for any type of currency could be provided so that major currencies such as U.S. Dollars, Chinese Yen, and European Euros could be entered by a computer user.

The supplier company name search parameter 235 can include any alphanumeric text that may uniquely identify a company that may supply objects similar to the one represented by the CAD Model 200. A computer user could enter the full name of any company or a truncated version of a company name with appropriate wild card characters for database searching known to one of ordinary skill in the art. Also, a computer user could enter multiple names if desired if multiple different companies manufacture objects similar to the one represented by CAD Model 200.

The date sourced search parameter 240 can comprise a calendar date and year of when a product may have been made or the subject of a request for proposal (RFP) or a request for a quote (RFQ). While a computer user can input a single date for the date sourced search parameter, in other embodiments (not illustrated) the computer user could input date ranges without departing from the scope of the invention.

### Process Data 207 of FIG. 2

The manufacturing process search parameter 218, which is classified under process data 207, can comprise data that describes how the object represented by the CAD model 200 is made. The manufacturing process parameters 218 listed in FIG. 2 include manufacturing through machining and molding. However, other manufacturing process parameters 218 (not listed in FIG. 2) are not beyond the scope of the invention.

For example, other manufacturing process parameters can include, but are not limited to, coating; anodizing; chemical conversion; chrome techniques including electroless plating and electroplating; galvanizing; painting; Teflon coating; thermal spraying; vacuum metalizing; engraving and/or marking using chemical, hand, label, laser, machine, and roll die techniques; fabricating techniques including filament winding, laser cutting, heavy fabrication, metal bonding, metal drawing, plasma cutting, precision welding, roll forming, sheet metal, bending, swaging, waterjet cutting, welding, brazing; specific categories of machining such as five axis machining, ceramic machining, chemical machining, CNC machining, sinker EDM, wire EDM, machining of castings, CNC milling, micro machining (miniature machining), plastic machining, CNC turning, screw machining, and swiss turning; specific categories of molding such as blow molding, compression molding, dip molding, injection molding, insert molding, layup molding, porous media molding, pour molding, reaction molding, rotational molding, structural foam molding, thermoforming, transfer molding, and vacuum forming; powdered metal techniques such as isostatically pressed, metal injection molded, powder forged, and press sinter; woodworking techniques including fabrication, finishing, joining/assembly, routing/drilling, turning; die making techniques including blanking die, clicker die, compound die, extrusion die, four-slide die, progressive die, stamping die, and steel rule die; finishing techniques including abrasive cleaning, chemical cleaning, deburring, electropolishing, honing, lapping, masking, metalizing, polishing, shielding, silk-screen printing, stripping, and tumble finishing; heat treating techniques including annealing, curing, hardening, and stress relieving; metal casting techniques including centrifugal casting, ceramic mold casting, die casting, investment casting, lost foam casting, near-net-shape casting, permanent mold casting (gravity die casting), plaster mold casting (plaster casting), sand casting, and shell casting; mold making such as blow mold, injection mold, patterns, reaction, rotational mold, structural foam, thermoform mold, and transfer mold; cold forming techniques such as cold heading, roll forming, and swaging; chemical manufacturing techniques such as blending, calcining, classification, drying, milling, screening, size reduction, and synthesis; extrusion techniques such as direct/indirect and hollow shape; forging techniques such as heading, hot, impression die, near net shape, open die, press, roll, swaging, and upset; grinding techniques including centerless, cylindrical, flat/surface, form, and jig; metal spinning techniques; metal stamping techniques including blanking, deep drawing, fourslide/four slide, metal coining, and progressive die stamping; and wire forming techniques including bending/forming, drawing, splicing, and weldment, just to name a few.

The material search parameter 223 can describe the materials used to make the object represented by the CAD model 200. As illustrated in FIG. 2, material options include stainless steel and plastic. However, one of ordinary skill in the art recognizes that numerous other materials exist and that can be listed under material information 223. Other exemplary materials not illustrated in FIG. 2 include, but are not limited to, any other types of metals such as Magnesium, Aluminum, Titanium, Chromium, Cobalt, Nickel, Copper, Zinc, Silver, and Lead, just to name a few; specific alloys of metals (i.e. Aluminum 2024, Aluminum 3003, Aluminum 5052, etc.); intermetallic compounds (high-temperature structural materials); ceramics including structural ceramics (high-temperature load bearing), refractories (corrosion-resistant, insulating), whitewares (e.g. porcelains), glass, electrical ceramics (capacitors, insulators, transducers, etc.), and chemically bonded ceramics (e.g. cement and concrete); polymers such as plastics, liquid crystals, and adhesives; electronic materials including silicon and germanium, compounds (e.g. GaAs), and photonic materials (solid-state lasers, LEDs); anc composites including particulate composites (small particles embedded in a different material); laminate composites, and fiber reinforced composites (e.g. fiberglass), just to name a few.

The part number search parameter 229, which is also classified under the process search parameter 207, can include any alphanumeric characters that may be associated with the object represented by the CAD model 200. Since part numbers are usually company specific, multiple part numbers may be supplied by a computer user if known. Also, a computer user could use any appropriate wildcard characters for searching if all digits of a part number are not known.

### Transactional Data 205 and Process Data 207 Left Blank in FIG. 2

In FIG. 2, transactional and process data 205, 207 have been left blank. Meanwhile, some of the technical attribute data 212 from the CAD model 200 has been generated. Specifically, the bounding box dimensions 215 have been generated or can be supplied by the computer user. In other words, these bounding box dimensions 215 can be calculated by an operator or by the geometry based searching engine 135 or other commercially available software.

As an example of one mode of operation, because the transactional data 205 and process data 207 have been left blank, a computer user may desire to perform a “geometry only” based search for the initial inquiry meaning that no values have been provided for transactional data 205 or process data 207.

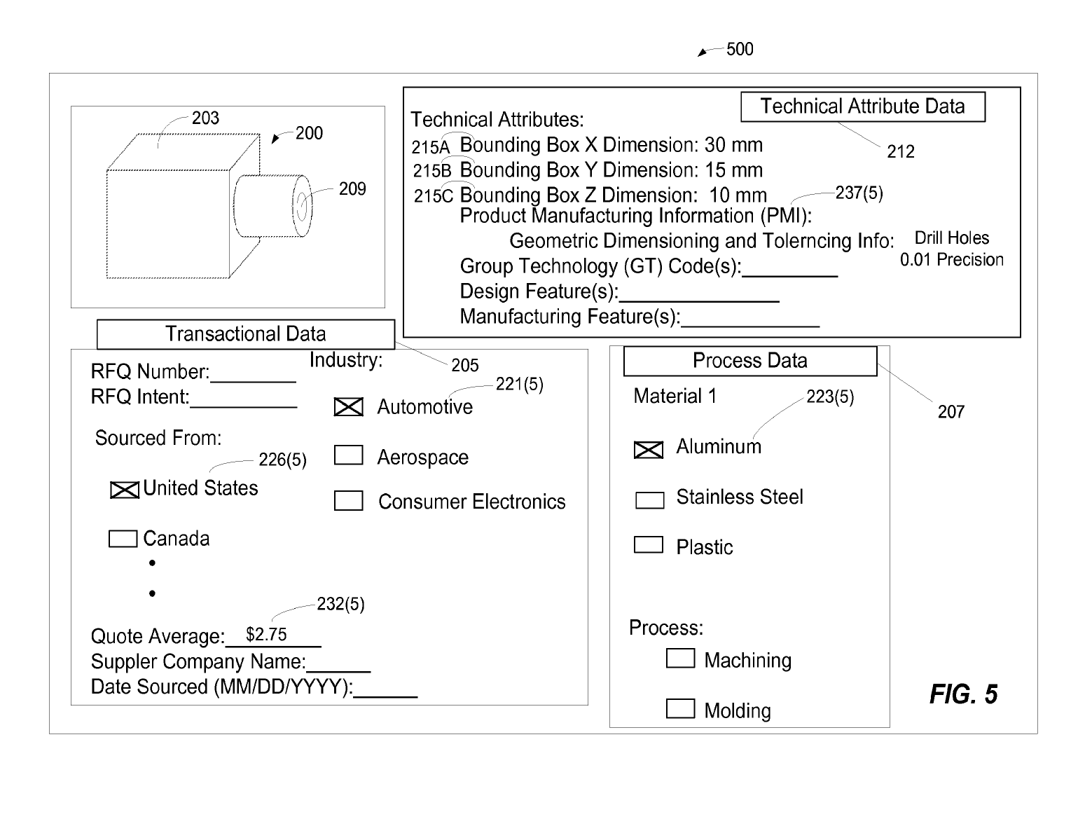

According to one exemplary embodiment of the invention, if any of the transactional or process (or both) search parameters were provided by the computer user (not illustrated in FIG. 2 but illustrated in FIG. 5), then the geometry based search engine 135 would make a first geometry index data search of the index CAD assets database 150. Next, the transactional based search engine 120 of the search manager 125 would make a second pass of the matching or similar hits discovered by the index data search, before any results would be displayed to the user.

### Geometry Only Search Results Display 300 of FIG. 3

Referring now to FIG. 3, this Figure illustrates an exemplary display of results from a geometry only search using geometry index data 800, 800A, 800C and technical attribute data 212 according to one exemplary embodiment of the invention. The search results of FIG. 3 are based on index data derived from the digital CAD model 200 of FIG. 2 and the values provided for the technical attribute data 212.

In display 300 of FIG. 3, three CAD models 200A, 200B, 200C were uncovered by the geometry based search engine 135 which uses the index data based on CAD model 200 and compares it to the index data associated with CAD models 200A, 200B, and 200C. First CAD model 200A has an accuracy match value 309A of ninety-nine percent, while second CAD model 200B has an accuracy match value 309B of eighty-six percent and third CAD model 200C has an accuracy match value of eighty percent.

The accuracy match value 309 can be based on variables computed by algorithms in the geometry based search engine 135, and/or other commercially available software. Other methods for calculating accuracy match values are not outside the scope of the invention. Accuracy match values are known to one of ordinary skill in the art.

The first CAD model 200A of FIG. 3 has the highest accuracy match value because its geometry is the closest to the original CAD model 200 of FIG. 2. Based on how the first CAD model 200A of FIG. 3 and original CAD model 200 of FIG. 2 were prepared for this disclosure, there should be no perceptible differences in geometry between these two CAD models. Meanwhile, the second CAD model 200B of FIG. 3 has some noticeable different physical features relative to the original CAD model 200 of FIG. 2: the second CAD model of FIG. 3 has a second hole 305 in addition to a first hole 209B in the cylinder 206B, and its surface area is a little larger relative to the original CAD model 200 of FIG. 2.

The third CAD model 200C of FIG. 3 also has some noticeable different physical features relative to the original CAD model 200 of FIG. 2: the third CAD model 200C of FIG. 3 has a longer cylinder 206C with a smaller diameter, as well as an end face 307 that does not have a hole relative to the original CAD model 200 of FIG. 2. While only three matches are illustrated in FIG. 3, it is understood that fewer or a greater number of matches are possible and could be displayed by the real-world market based search system 100, depending upon the amount of matching CAD models and corresponding transactional and/or process data assessed. According to one exemplary embodiment of the invention, a user could specify the number of matches that may be displayed as a result of a given search query.

The display 300 provides reduced sized images, also referred to as thumbnail sketches, of CAD models 200 as well as selected transactional and process data 312. As a non-limiting example, the selected transactional and/or process data can comprise quantity parameters 303 that indicate how many objects based on the CAD models 200A-C were actually produced in delivery of a transaction that was recorded in the real-world database 175 of FIG. 1.

While not illustrated, under a preferences menu, a computer user could select default transactional and process data 312 that should be displayed after every search. Also, any of the information positioned on the display 300 may contain links, such as hybertext links or thumbnail images links, to additional files that may provide more information about a particular CAD model 200. For example, the first, second, and third CAD models 200A-200C may have hypertext links to more detailed files such that when the computer user selects a particular CAD model 200 in display 300, the computer user could be presented with additional information such as the full record of the transactional data and process data for the selected CAD model 200. Alternatively, “additional information” cues or selection boxes could be positioned adjacent to each CAD model that could activate or bring up the full records as noted above if selected by the computer user. Other graphical user interfaces (GUIs) and usage workflows not described are within the scope of the invention.

### Selectable Accuracy Match Value Scale 405 of FIG. 4

Referring now to FIG. 4, this figure is an exemplary display 400 of the sample computer aided design (CAD) model 200 of FIG. 2 that was provided by a user and which lists relevant technical attribute data 212 of the CAD model 200 and/or transactional data 205 and process data 207 that may have been searched according to one exemplary embodiment of the invention. For this exemplary embodiment, only the bounding box dimensions 215 of the technical attribute data 212 are displayed to the user. Alternatively (and not illustrated), a user may select default technical attribute data 212, transactional data 205, and process data 207 that are displayed adjacent to the CAD model 200 of this display 400. The display 400 of FIG. 4 could be provided adjacent to the results display 300 of FIG. 3.

The display 400 also comprises a selectable accuracy match value scale 405. In one exemplary GUI implementation, a computer user could select a movable pointer 410 to indicate how closely matched the next search results should be for subsequent search queries. Other ways to adjust the accuracy match value are not beyond the scope of the invention. In alternative embodiments (not illustrated), a computer user could type in a numerical value in an on screen field or select a drop down menu with values to adjust the accuracy match value.

User-controlled filters could be set to control the number of models that are returned as a result of the search. A low value would open the filter allowing relatively many models to be returned as the result of a search, while a higher value would return fewer models. The geometry based search engine 135 can use these accuracy match values in their internal algorithms to select, for example, any parts with similar shape or topology as parts represented by CAD models 200A and 200B, and wherein the bounding box X dimension 215A might have a value ranging from 25 to 35 millimeters.

The transactional search engine 120 can use these accuracy match values in its internal algorithms to select, for example, any parts with similar transactional parameters as parts represented by CAD models 200A and 200B, and wherein their unit cost might have a value ranging from $3.50 to $4.50.

Refining Search Results with Transactional Data 205 and Process Data 207 of FIG. 5

Referring now to FIG. 5, this figure is an exemplary list of transactional data 205 and process data 207, similar to FIG. 2 that can be used to filter the search results of FIG. 3 or to initiate transactional only searches in which only a few parameters have been selected by a user according to one exemplary embodiment of the invention. Since FIG. 5 is substantially similar to FIG. 2, only the differences between these two figures will be described with respect to FIG. 5.

In this Figure, the transactional data 205 of Industry 221(5) (Automotive), sourced from 226(5) (United States), and quote average 232(5) ($2.75) were selected by the computer user to further filter the search results of FIG. 3. The process search parameter 297 of material 223(5) (Aluminum) was also selected. The technical attribute data parameter 212 of Geometric Dimensioning and Tolerancing (GD&T) information (holes that are drilled with 0.01 precision) was also provided.

### Refined Search Results Display 600 Based on Filter Selections of FIG. 5

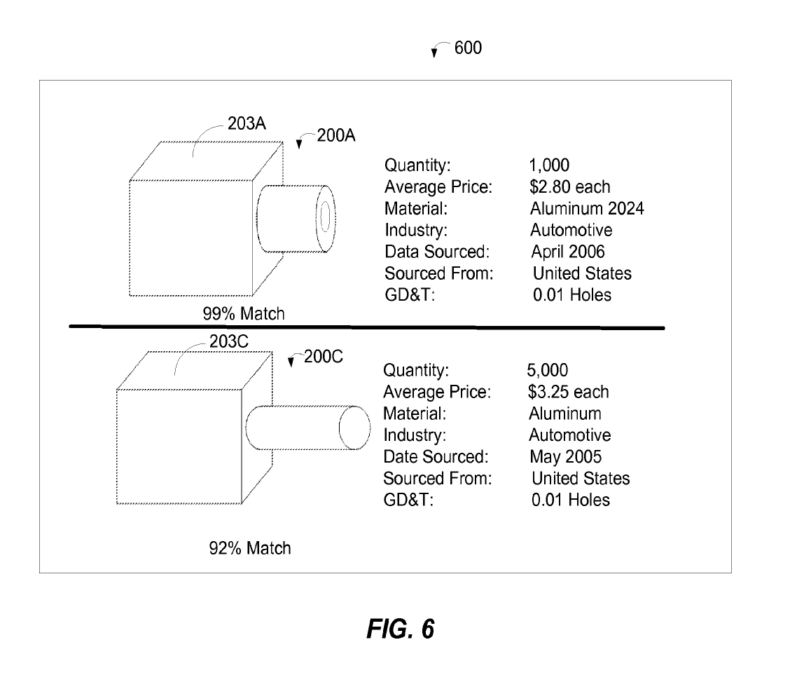

Referring now to FIG. 6, this figure is an exemplary display 600 of refined or filtered results from a transactional and process search that used the parameters selected in FIG. 5 to further filter the geometric index data search results illustrated in FIG. 3 according to one exemplary embodiment of the invention. Since FIG. 6 is substantially similar to FIG. 3, only the differences between FIG. 6 and FIG. 3 will be described.

In FIG. 6, the second CAD model 200B of FIG. 3 is not present because, although it has similar shape, it exhibits the following differences: its process search parameter 205 of material 223 (Copper) did not match the selected material 223 (5) of FIG. 5 which was aluminum; its average price value 232 ($1.75) was substantially lower than the selected value 232(5) of $2.75 plus or minus the accuracy value; and its geometry was different where the second CAD model had a larger surface area in general and the cube 203 had a hole 305. It is noted that the lower price value 232 of $1.75 may be a desirable value relative to the selected value 232(5) of $2.75, but this was only pointed out as a difference in transactional data between the CAD models 200.

Meanwhile, the first CAD model 200A and third CAD model 200C are displayed in FIG. 6. The only differences between the selected transactional, process, and technical attribute data parameters for the original CAD model 200 of FIG. 5 and the first and third CAD models 200A and 200C are the average price value 232 and the technical attribute data for the third CAD model 200C which has a longer cylinder 206 and that does not have a hole 209 on its end face 207.

The inventive market-based search system 100 allows a computer user to make iterative changes to technical attribute data, transactional, and process data values that are most important to the user, which is dependent upon the particular business context of the computer user. With this approach, the computer user can refine the geometric index data search results in such a way that is customized to the computer user and his or her particular business context.

Calculating Index Data from Shape Signatures Tied to Geometric CAD Model 200 in FIG. 7A

Referring now to FIG. 7A, this figure is a schematic of how index data 800, 800A, 800B (See FIG. 8) may be calculated from a geometric CAD model 200 according to one exemplary embodiment of the invention. The geometry based search engine 135 and other software tools, such as any 3-D CAD computer software, may use several different algorithms to calculate index data from various shape signatures for CAD model 200.

According to the exemplary embodiment illustrated in FIG. 7A, the geometry based search engine 135 can generate index data from one or more shape signatures for CAD model 200. The exemplary shape signatures described below have been simplified for easy understanding. One of ordinary skill in the art recognizes that other, more complex shape signatures and not described in this disclosure are included within the scope of the invention.

The exemplary shape signatures of FIG. 7A can include the geometry based search engine 135 calculating lengths and directions of vectors A-E taken from points P1 and P2 in space relative to the geometric CAD model 200. The geometry based search engine 135 can classify the length and direction of each vector A-E, so that each vector A-E has two floating point numbers.

These vectors A-E can be positioned all around the geometry of the CAD model 200 so that CAD model 200 can be represented as a set of multiple floating point numbers corresponding to the vectors. These floating point numbers can form the index data for CAD model 200. As noted above, these values, such as the vectors measured around the CAD model 200, are only example shape signatures that can be used to form the index data associated with the exemplary digital CAD model 200.

According to other exemplary embodiments (not illustrated) for generating index data from other types of shape signatures, a mathematical algorithm for another shape signature of the geometry based search engine 135 can first render an object or sketch of three-dimensional elements called voxels. It then maps these voxels onto a grid that is projected onto a sphere to derive a set of spherical-based math functions, which are then broken into component parts that digitally describe a unique shape. This set of such spherical shape descriptors provide a unique abstraction of the overall shape of the CAD model 200.

Other shape signatures known to one of ordinary skill in the art that can produce index data for the CAD model 200 include, but are not limited to: shape distribution functions, which represent the shape of the CAD model 200 as a probability distribution sampled from a “shape function” measuring geometric properties of the CAD model 200; computing reflective symmetry descriptors of two-dimensional and three-dimensional shapes, representing a shape as a measure of reflective symmetry for an arbitrary three-dimensional voxel model for all planes through the center of mass of the CAD model 200, and skeletal graphs, in which one dimensional skeletal curves are derived from the CAD model 200 such that each curve can represent a significant part of the object. These curves can then be converted to an attributed graph representation, or “skeletal graph”, which can be used for indexing, shape matching, segmentation, etc.

In summary, FIG. 7A illustrates exemplary algorithmic detail of how the geometry based search engine 135 may index digital CAD models 200 with unique shape signatures that are associated with the CAD model 200 to form the index data 800, 800A, 800B (See FIG. 8). The invention is not limited to only this type of shape signature calculation illustrated in FIG. 7A. Other algorithms and software for calculating other shape signatures that form the index data of the indexed CAD assets database 150 are not beyond the invention.

In addition to using one or more shape signatures to calculate the index data for CAD model 200, the geometry based search engine 135 can also determine attribute data 212 for the CAD model 200 such as the bounding box 705. The bounding box 705 can be designed such that it completely envelopes the CAD model 200.

The geometry based search engine 135 and other software tools can analyze the geometric CAD model 200 and generate various other technical attribute data 212 (that is usually not indexed but can be used by the search manager 125 to refine results of geometry index data searches) such as the center of mass (CM) as well as moments of inertia along the X, Y, and Z co-ordinate plane directions, or the exact length of one side of the object, for example BoxY. This technical attribute data 212 illustrated in FIG. 7 are only examples of numerous geometric parameters that may be derived from the CAD model 200 by the geometry based search engine 135.

FIG. 7B: Bar Graph of Vector Magnitudes from Point P1

Referring now to FIG. 7B, this figure is a bar graph 710 illustrating magnitudes of vectors A-C relative to a first point P1 positioned in space relative to the geometric CAD model 200 illustrated in FIG. 7A. The magnitudes from vectors A-C form the indexing data 700A that is stored in the indexed CAD database 150 according to one exemplary embodiment of the invention.

Vectors A and B have magnitudes of five while the third Vector C has a magnitude of 7. Vector A could be assigned a direction value of 1; Vector B a value of 0; and Vector C a value of −1. The geometry based search engine 135 could index the values of these Vectors as follows: A (1, 5); B (0, 5); and C (−1, 7). The foregoing is a simplified example for calculating values from an exemplary shape signature involving vectors. The invention may include much more robust shape signatures than those described and illustrated.

FIG. 7C: Bar Graph of Vector Magnitudes from Point P2

Referring now to FIG. 7C, this figure is a bar graph 715 illustrating magnitudes of vectors D-E relative to a second point P2 positioned in space relative to the geometric CAD model 200 illustrated in FIG. 7A. The magnitudes from vectors A-C form the indexing data 700B that is stored in the indexed CAD database 150 according to one exemplary embodiment of the invention.

Vector D has a magnitude of 6 while Vector E has a magnitude of 8. Vector D could be assigned a direction value of 1 and Vector E a value of −1. The geometry based search engine 135 could index the values of these vectors as follows: D (1, 6); and E (−1, 8). The foregoing is a simplified example for calculating values from an exemplary shape signature involving vectors. The invention may include much more robust shape signatures than those described and illustrated.

With this index data of A (1, 5); B (0, 5); C (−1, 7); D (1, 6); and E (−1, 8) for Vectors A, B, C, D, and E, the geometry based search engine 135 can compare these vector values with values found in the indexed CAD database 150. If matching or similar values are found, the geometry based search engine 135 can pass these values to the search manager 125 which can use the mapping table 133 to locate corresponding full records of transactional data 205, process data 207, and technical attribute data 212 stored in real-world transactional database 175.

### Sample Tables Used by Geometry Based Search Engine 135 and Transactional Search Engine 120

Referring now to FIG. 8, this Figure is a diagram illustrating five exemplary tables 803, 805, 810, and 813 that simulate how data can be managed by the geometry based search engine 135 and the transactional search engine 120 according to one exemplary embodiment of the invention. This sequence indicated in arrows between these tables 803, 805,810, and 813 is illustrative only.

The first table 803 illustrates a sample search query of index data 800 that can be used by the geometry based search engine 135 to find similar CAD models 200A, 200B, 200C in the CAD assets database 150, and then later by the transactional search engine 120 of search Manager 125 to find similar transactions performed involving any uncovered similar CAD models 200A. According to one exemplary embodiment of the invention, the geometry index data search in most cases will usually be first to find similar CAD models 200A, 200B, 200C. Next, a user can then refine the results of the geometry index search with the search manager 125 using technical attribute data 212, transactional data 205 or process data 207, or any combination thereof.

The arrows in FIG. 8 are numbered to suggest a sequence in which data may be compared between the tables which represent the data stored in the indexed CAD asset database 150 and the real-world database 175. The first table 803 contains index data 800 that is from a shape signature taken from the CAD model 200 of FIG. 2. This index data is described above in connection with FIGS. 7B and 7C.

The second Table 810 contains the results of indexing the digital CAD models 200A, 200B, 200C of FIG. 3 and that are stored in the indexed CAD assets database 175. The third table is a portion of the mapping table 133 illustrated in FIG. 1. The fourth table 815 contains technical attribute data 212, transactional data 205, and process data from real-world transactional database 175. The fifth Table 805 contains technical attribute data 212 and transactional data 205 entered by a computer user that may be used by the transactional search engine 120 to refine geometric index data search results.

The first sequence arrow 1 illustrates how index data 800 of the first table 803, which represents shape signature results of a computer user's inquiry for the CAD model 200 of FIG. 2, may be compared by the geometry based search engine 135 to index data 800A, 800B in the second table 810. If the index data 800 in first table 803 matches the index data 800A, 800B of second table 810 for a particular CAD model 200A, 200B, then the second sequence arrow 2 indicates that the data from the mapping table 133 can be accessed by the transactional search engine 120 of the search manger 125.

An exemplary mapping table 133 can comprise at least two columns of data: a left column 811 that identifies indexing data of each CAD model 200A, 200B, 200C; and a right column 813 that lists record numbers for full records of data found in the real-world database 175.

In the example illustrated in FIG. 8, since the index data 800 of the first table 803 matches the indexing data 800A for a matching or similar digital CAD model 200A of the second table 810, then the corresponding CAD model 200A (See Sequence Arrow 2) of the mapping table 133 can be used by the transactional search engine 120 of the search manager 125 to identify the record number (Record #823) of the real-world database 175 that contains all of the real-world transactional data associated with CAD model 200A.

The third sequence arrow 3 indicates how the record number (Record #823) from the mapping table 133 can be used by the transactional search engine 120 to uncover the related transactional and process data from record 823 of the real-world database which corresponds to the CAD model 200A. The fourth arrow 4 indicates how the transactional search engine 120 may compare the transactional data and process data of record 823 with the transactional data 205 and technical attribute data 212 entered by the computer user and present in fifth table 805.

FIG. 8 illustrates how the index data of a CAD Model 200 of FIG. 2 can be used to uncover records in the real-world database 175 of potential matches or similar CAD models 200A, 200B, 200C and corresponding transactional, process, and technical attribute data.

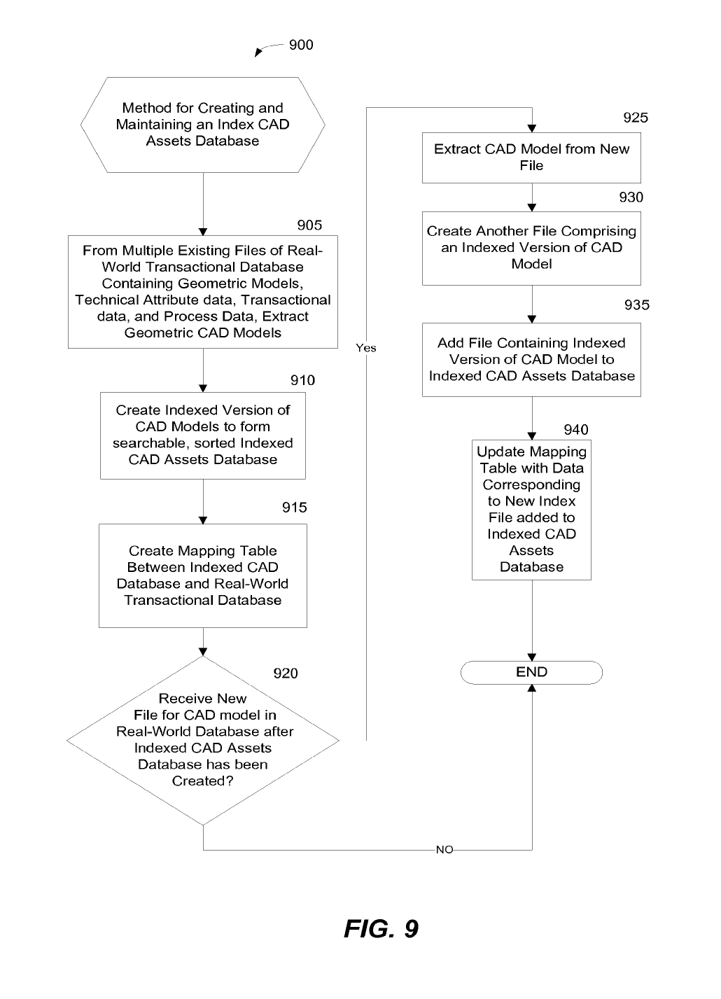

### Creating and Maintaining Indexed Database 150 for Technical Attribute Data of FIG. 9

Referring now to FIG. 9, this figure is a logic flow diagram illustrating an exemplary method 900 for creating and maintaining an indexed CAD assets database 150 that can be used in exemplary embodiments of the invention. The processes and operations of the real-world transactional matching system 100 described below with respect to all of the logic flow diagrams may include the manipulation of signals by a processor and the maintenance of these signals within data structures resident in one or more memory storage devices. For the purposes of this discussion, a process can be generally conceived to be a sequence of computer-executed steps leading to a desired result.

These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as listing, creating, adding, calculating, comparing, moving, receiving, determining, configuring, identifying, populating, loading, performing, executing, storing etc. that are often associated with manual operations performed by a human operator. The operations described herein can be machine operations performed in conjunction with various input(s) provided by a human operator or user that interacts with the computer.

In addition, it should be understood that the programs, processes, methods, etc. described herein are not related or limited to any particular computer or apparatus. Rather, various types of general purpose machines may be used with the following process in accordance with the teachings described herein.

The present invention may comprise a computer program or hardware or a combination thereof which embodies the functions described herein and illustrated in the appended flow charts. However, it should be apparent that there could be many different ways of implementing the invention in computer programming and/or hardware design, and the invention should not be construed as limited to any one set of computer program instructions.

Further, a skilled programmer would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer-implemented processes will be explained in more detail in the following description in conjunction with the remaining Figures illustrating other process flows.

Further, certain steps in the processes or process flow described in all of the logic flow diagrams below must naturally precede others for the present invention to function as described. However, the present invention is not limited to the order of the steps described if such order or sequence does not alter the functionality of the present invention. That is, it is recognized that some steps may be performed before, after, or in parallel with other steps, without departing from the scope and spirit of the present invention.

Referring again to FIG. 9, step 905 is the first step in the exemplary process 900. In step 905, geometric CAD models 200 are extracted by the indexing software module 165 from multiple existing records of the real-world transactional database 175 of FIG. 1 that may contain the CAD models 200 in addition to topology, transactional data 205, technical attribute data 212, and/or process data 207. Alternatively, instead of extracting each CAD model 200, each CAD model 200 of each file in the real-world transactional database 175 can be assessed by the indexing software module 165.

The real-world database 175 is maintained on a computer server, which may be accessible through a website, such as MFG.com, that supports business transactions and searches between designers and manufacturers, as discussed above with respect to FIG. 2.

Next, in step 910, the indexed versions of the CAD models 200A, 200B, 200C are created by the indexing software module 165 in order to form a searchable, indexed CAD assets database 150. This step 910 can also include a substep of sorting all of the indexed versions of the CAD models 200A, 200B, and 200C. In this step, indexing software module 165 uses one or more shape signatures as described in connection with FIGS. 7B and 7C to generate index data 800A, 800B illustrated in FIG. 8.

Next, in step 915, a mapping table 133 may be created by the indexing software module 165 in order to map or link the indexed CAD assets database 150 with the full records of real-world database 175. The full records 823, 825 of the real-world database 175 contain transactional data 205, process data 207, and technical attribute data 212. The mapping table 133 may or may not be a separate file and most often will likely be part of database functionality of the indexed CAD assets database 150 or real-world database 175 (or both), however, it has been described as a separate file for illustrative purposes to describe the data that may be searched and uncovered with the geometry based search engine 135 and transactional search engine 120.

Next in decision step 920, the indexing software module 165 or a human operator (or both) can determine if new files of new CAD models 200, such as from RFQs, have been received by the real-world database 175 after the indexed CAD assets database 150 has been created. If the inquiry to decision step 920 is negative, then the “no” branch is followed in which the process 900 ends.

If the inquiry to decision step 920 is positive, then the “yes” branch is followed down to step 925 in which the new CAD model 200 is extracted by the indexing software module 165 from the file. Alternatively, as noted above, instead of extracting the new CAD model 200, the indexing software module 165 can assess the new CAD model 200. This step 920 can also be performed by a human operator who can key-in this information. Alternatively and preferably, the indexing software 165 can perform this step.

In step 930, another file or record comprising an indexed version of the CAD model 200 is created by the indexing software module 165. Step 930 is usually performed by indexing software 165.

In step 935, the new file containing the indexed version of the CAD model 200 can be added to the indexed CAD assets database 150. In step 940, the mapping table 133 can be updated with data corresponding to the newly received file that is added to the indexed CAD assets database 150. The process then ends.

### Method for Identifying Similar Real-World Products Using Indexed Versions of CAD Models 200

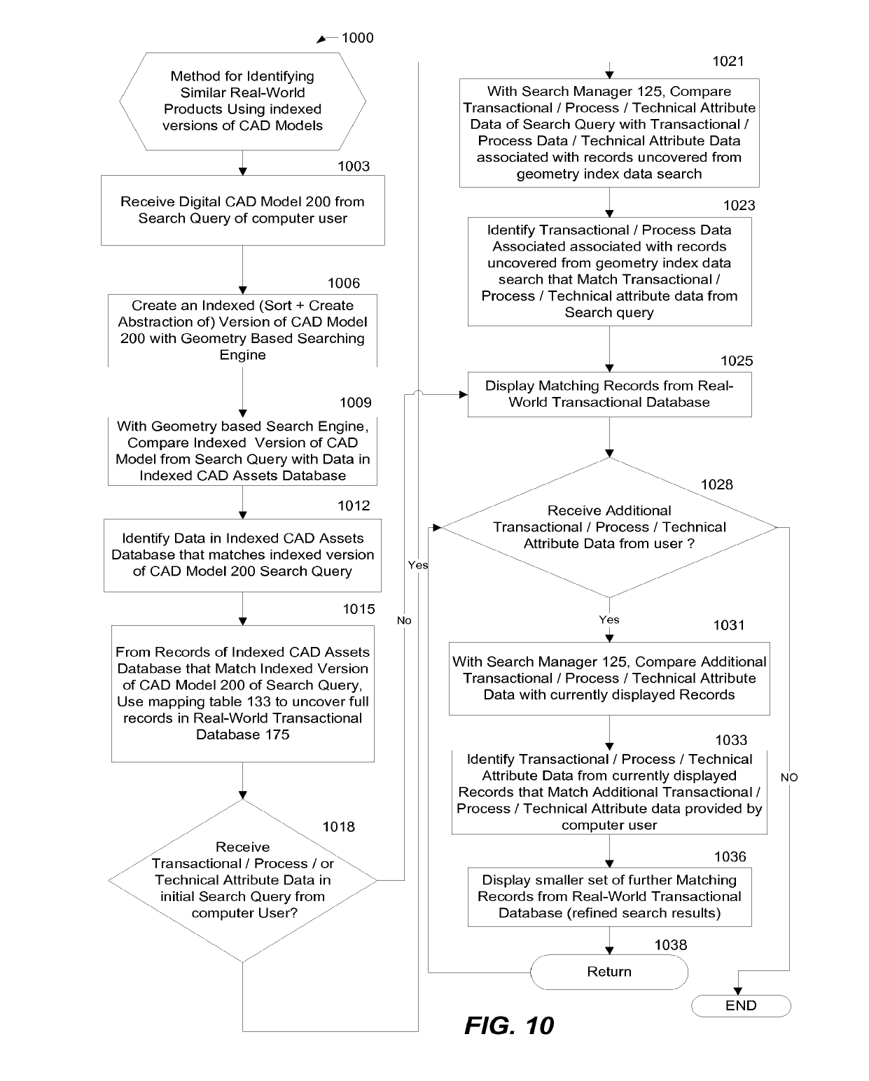

Referring now to FIG. 10, step 1003 is the first step in the exemplary process 1000 for Identifying Similar Real-World Products Using indexed versions of CAD models 200 according to one exemplary embodiment of the invention. In step 1003, the geometry based search engine 135 receives a digital CAD model 200 from a search query comprising a CAD file 152. Next, in step 1006, the geometry based search engine 135 can create an indexed version of the CAD model 200. The indexed version of the CAD model 200 is usually an abstraction of the geometry and topology data contained in the CAD file 152 which is usually sorted for increased searching efficiency. Specifically, in this step 1006, indexing software module 165 uses one or more shape signatures as described in connection with FIGS. 7B and 7C to generate index data 800 for CAD model 200 illustrated in FIG. 8.

In step 1009, the indexed version 800 of the CAD model 200 is compared by the geometry based search engine 135 to the index data 800A, 800B of the indexed CAD assets database 150. In step 1012, the geometry based search engine 135 identifies index data 800A, 800B of the indexed CAD assets database 150 that matches or corresponds closely with the indexed version 800 of the CAD model 200 taken from the CAD file 152 (search query).

In step 1015, from the records of the indexed CAD assets database 150 that match or closely correspond with the indexed version of the CAD model 200 from the search query, the transactional search engine 120 of the search manager 125 uses the mapping table 133 to retrieve full records of transactional data 205, process data 207, or technical attribute data 212 in the real-world database 175 that correspond with the matching or similar records 800A, 800B.

Next in decision step 1018, the search manager 125 determines if the initial search query includes transactional data 205, process data 205, or technical attribute data 212, or a combination thereof supplied by the computer user. If the answer to decision step 1018 is negative, then the “no” branch is followed to step 1025 in which the search manager 125 displays the matching records from the real-world transactional database 175 that correspond with the matching index data records.

If the inquiry to decision step 1018 is positive, then the “yes” branch is followed down to step 1021 in which the transactional search engine 120 of the search manager 125 compares the additional transactional data 205, process data 207, or attribute data 212, or a combination thereof found in the search query with the matching records from the real-world transactional database 175.

In step 1023, the transactional search engine 120 identifies the transactional data 205, process data 207, or technical attribute data 212, or a combination thereof with records discovered from the geometry index data search that match the data from the search query.

In step 1025, the transactional search engine 120 displays records from the real-world transactional database through the GUI 140 onto a viewing device, such as on a display of the client computer 105, that have transactional data 205, process data 207, or technical attribute data 212 that match or are similar to the data of the initial search query.

Next, in decision step 1028, the transactional based search engine 120 of the search manager 125 determines if additional search query data is entered by the computer user after display of the matching records. If the inquiry to decision step 1028 is negative, then the “no” branch is followed and the process 1000 ends.

If the inquiry to decision step 1028 is positive, then the “yes” branch is followed down to step 1031, in which the transactional search engine 120 of the search manager 125 compares the transactional data 205, process data 207, or technical attribute data 212 or combination thereof found in the subsequent search query with the currently displayed search results.

In step 1033, the transactional search engine 120 identifies the transactional data 205, process data 207, or technical attribute data 212, or combination thereof of the currently displayed records that match with the additional transactional data 205, process data 207, or technical attribute data 212 provided in the subsequent search query by the computer user such as illustrated in FIG. 5. In step 1036, the transactional search engine 120 displays a smaller set of data records through the GUI 140 onto a viewing device, such as on a display of the client computer 105, that have transactional data 205, process data 207, or technical attribute data 212, or a combination thereof that match or are similar to the transactional data 205, process data 207, and technical attribute data 212 of the subsequent search query. In step 1038, the process returns back to decision step 1028 which determines if additional search parameters have been entered by the computer user.

### Potential Users of Inventive Transactional Based Search System

One category of potential users who can benefit from this market or transactional-based search system is purchasing people. Purchasing people can search by finding similar RFQs that have been sourced. Purchasing people will also be able to compare suppliers. With all of the available search parameters of the inventive market-based search system, purchasing people will be able to compare all current RFQs managed by them, all RFQs not managed by them, and all RFQs in general. Purchasing people who use the inventive market-based search system would, for example, use such comparison parameters as price range, supplier rating, quality rating, and/or territory in order to decide which supplier to use.

Another category of users of the inventive market-based search system are those individuals or companies looking for potential suppliers. The inventive market-based system allows users to look, for example, at past suppliers, past business with particular customers, jobs that were awarded, jobs that were not awarded, jobs that were lost, and/or all jobs.

Another category of users of the inventive market-based search system are supplier companies looking at their past proposals and projects. The inventive market-based system allows users to look, for example, at past business with particular customers, jobs that were awarded, jobs that were not awarded, jobs that were lost, and/or all jobs.

Design engineers can benefit from this market-based search system. Design engineers can search for similar designs by price, by a rating system, and by a specific geographic territory. And within the rating system, the design engineers can search among all of their current RFQs managed by them, all RFQs not managed by them, and all RFQs in general.

Other classes of users, not necessarily described above, could easily find value in the use of the inventive market-based search system.

It should be understood that the foregoing relates only to illustrate the embodiments of the invention, and that numerous changes may be made therein without departing from the scope and spirit of the invention as defined by the following claims.

What is claimed is:

1. A computer-implemented method for identifying market-based cost information based on a computer aided design (CAD) model, comprising:
receiving a first CAD model;
creating an indexed version of the first CAD model;
comparing the indexed version of the first CAD model with index data of a database;
identifying index data of the database that matches the indexed version of the CAD model;
retrieving at least one of transactional data, process data, technical attribute data, and at least one second CAD model associated with the matching indexing data; and
displaying at least one of transactional data, process data, technical attribute data, and at least one second CAD model associated with the matching indexing data.

2. The method of claim 1, wherein each CAD model comprises a two-dimensional CAD model.

3. The method of claim 1, wherein each CAD model comprises a three-dimensional CAD model.

4. The method of claim 1, wherein creating an indexed version of the CAD model further comprises calculating index data from a shape signature.

5. The method of claim 1, wherein the technical attribute data comprises at least one of vertices, edges, faces, bodies, a unit measure of size, a unit measure of weight, mass, a center of mass, density, an axis of inertia, a principal moment of inertia, a surface area, a volume, a diameter, a length, a width, a height, an aspect ratio, a bounding box parameter, and topology data.

6. The method of claim 1, wherein the technical attribute data further comprises one of Product Manufacturing Information (PMI), a Group Technology (GT) code, a design feature, and a manufacturing feature.

7. The method of claim 6, wherein the Product Manufacturing Information (PMI) comprises Geometric Dimensioning and Tolerancing (GD&T) information.

8. The method of claim 1, wherein the transactional data comprises at least one of a request for quote (RFQ) number, RFQ intent, RFQ purpose, number of quotes received, number of quotes prepared, quote average, quote median, quote awarded, quote by date, anticipated award date, delivery date, unit of measure corresponding to a CAD model, number of RFQs awarded, number of RFQs posted, a company name, company size, supplier name, supplier type of business, quality certifications, special business status, part number, Skype identification (ID), star rating, industry, process, subprocess, material, material grade tooling, target price, baseline price, ITAR compliance status, part number, part name, and quantity of goods.

9. The method of claim 1, wherein the process data comprises one of a manufacturing process, a material, a finish, a tolerance, a part number, a part name, and product version number

10. A computer-implemented method for identifying cost information of a computer aided design (CAD) model, comprising:
comparing index data from a CAD model with data of an indexed database;
identifying data of the indexed database that matches the index data;
retrieving at least one of transactional data, process data, technical attribute data, and at least one second CAD model associated with the matching indexing data;
receiving at least one of transactional data, process data, and technical attribute data from a search query;
comparing the at least one transactional data, process data, and technical attribute data from the search query with the retrieved data; and
displaying at least one of transactional data, process data, technical attribute data, and at least one second CAD model associated with the retrieved data that matches the data of the search query.

11. The method of claim 10, wherein the CAD model comprises a two-dimensional CAD model.

12. The method of claim 10, wherein the CAD model comprise a three-dimensional CAD model.

13. The method of claim 10, wherein the CAD model comprises one of TIFF, PDF and JPEG image data.

14. The method of claim 10, wherein the technical attribute data comprises at least one of vertices, edges, faces, bodies, a unit measure of size, a unit measure of weight, mass, a center of mass, density, an axis of inertia, a principal moment of inertia, a surface area, a volume, a diameter, a length, a width, a height, an aspect ratio, a bounding box parameter, and topology data.

15. The method of claim 10, wherein the technical attribute data further comprises one of Product Manufacturing Information (PMI), a Group Technology (GT) code, a design feature, and a manufacturing feature.

16. The method of claim 15, wherein the Product Manufacturing Information (PMI) comprises Geometric Dimensioning and Tolerancing (GD&T) information.

17. A computer-implemented system for matching computer aided design (CAD) models with price information comprising:
a geometry based search engine for creating an indexed version of a first CAD model; for comparing the indexed version of the first CAD model with data of an indexed database, for identifying data of the indexed CAD database that matches the indexed version of the first CAD model; and
a transactional search engine coupled to the geometry based search engine for retrieving at least one of transactional data, process data, and technical attribute data associated with matching data of the indexed CAD database; and for displaying at least one of matching transactional data, process data, and technical attribute data corresponding with a second CAD model that matches the first CAD model.

18. The system of claim 17, further comprising a client computer running on one of an Internet web browser and a stand-alone computer program.

19. The system of claim 18, further comprising a graphical user interface (GUI) for exchanging information between the geometry based search engine and the client computer, and for exchanging information between the transactional search engine and the client computer.

20. The system of claim 17, wherein the transactional data comprises at least one of a request for quote (RFQ) number, RFQ intent, RFQ purpose, number of quotes received, number of quotes prepared, quote average, quote median, quote awarded, quote by date, anticipated award date, delivery date, unit of measure corresponding to a CAD model, number of RFQs awarded, number of RFQs posted, a company name, company size, supplier name, supplier type of business, quality certifications, special business status, part number, Skype identification (ID), star rating, industry, process, subprocess, material, material grade tooling, target price, baseline price, ITAR compliance status, part number, part name, and quantity of goods.
